(19) United States
(12) Patent Application Publication
(10) Pub. No.: US 2026/0257864 A1
(43) Pub. Date: Sep. 3, 2026

(54) CONVEYING UNIT FOR THE SUSPENDED TRANSPORT OF TRANSPORT ELEMENTS FOR CONVEYED ITEMS AND A CONVEYING FACILITY WITH CONVEYING UNITS

(71) Applicant: Ferag AG, Hinwil (CH)

(72) Inventors: Roberto Fenile, Hinwil (CH); Simon Guhl, Hinwil (CH)

(21) Appl. No.: 19/551,738

(22) Filed: Feb. 27, 2026

(30) Foreign Application Priority Data
Feb. 28, 2025 (CH) 000197/2025
Sep. 10, 2025 (CH) 001050/2025

(51) Int. Cl. B65G 17/20; B61B 3/00; B61C 11/02; B65G 17/48

(52) U.S. Cl. CPC B65G 17/20; B61B 3/00; B61C 11/02; B65G 17/485; B65G 2203/0266

(57) ABSTRACT

A conveying unit for suspended transport of conveyed items. The conveying unit includes a conveying element with a carrier hook and a transport element. The transport element includes transport pockets that include of frame structures which are provided with a suspension hook attached to the frame structure. The suspension hook is mounted in the carrier hook of the conveying element in a suspended manner. The transport element has at least two transport pockets and each transport pocket in the conveying direction includes a leading and a trailing pocket wall that are connected to one another via a pocket base section. The pocket walls of the two transport pockets are formed of different materials, wherein the pocket wall material of the first transport pocket is a soft, supple material and the pocket wall material of the second transport pocket is a shape-stable, firm material.

The present invention relates to the field of transport and conveying technology, in particular intralogistics. It concerns a conveying unit for the suspended transport of transport elements, in particular transport pockets, in a conveying facility, in particular in a rail-led conveying facility or in a conveying chain facility and it further relates to a conveying facility with such conveying units, according to the preambles of claims 1 and 16.

### TECHNOLOGICAL BACKGROUND

In automated warehouses, vast production facilities and very generally concerning the conveying and transport of goods, suspended conveying systems have been proven to be an efficient means for the transport, the intermediate buffering, but also the long-term storage of different types of goods. Regarding suspended conveying systems, in a suitable manner the goods are either suspended directly on individual conveying elements of a conveying system, for example coat hangers with pieces of clothing which are suspended thereon, or are brought into suitable transport elements such as for example transport pockets which in turn are mounted on the conveying elements in a suspended manner.

Suspended conveying systems can be realised as transport chain facilities, concerning which a multitude of conveying elements form links of a chain which is moved along a conveying path.

Likewise known are gravity-assisted conveying systems, concerning which individual conveying elements which are provided with wheels, such as runner vehicles, move on corresponding runner rails. One example of such a gravity-assisted, rail-led conveying system is known from WO 2016/030275 A1 of the applicant.

Suspended conveying systems with transport elements are particularly suited for the efficient conveying of heterogenic individual item goods such as for example workpieces in production processes, spare parts, consumer goods such as books, pieces of clothing, shoes, etc.

Hence for example suspended conveying systems can be used in logistics centres of mail order companies, in order to store a multitude of articles of a different size and weight and to order pick groups of articles according to the respective customer orders and to prepare them for shipping.

Herein, an aspect which is relevant to a suspended conveying system is the simple, smooth-running and efficient bringing of goods into empty transport elements and the unloading of the goods from the transport elements.

A manual filling of provided, empty transport elements such as for example transport pockets permits a flexible, gentle handling of different goods, but is slow and cost-intensive.

It is thus known from the state of the art to apply suspended conveying devices with conveying pockets for the transport of goods or articles, hereinafter called conveyed items for simplicity.

The publication documents DE 10 2004 018569 A1 and U.S. Pat. No. 11465847 B2 for example describe a suspended conveying device with a plurality of conveying or collection pockets which can be folded together, for receiving and for the sorting collecting of objects, in particular pieces of clothing. The collecting pocket comprises a pivotable frame mount and a pocket pouch which is suspended on the frame mount. The collection pocket is suspended on the suspended conveying device or on a runner vehicle via a hook connection element which is attached to the frame mount.

The advantage of conveying pockets lies in the fact that these are designed in a foldable manner. By way of this, the receiving compartment can be compressed by way of folding together. In this manner, the conveying pockets permit space-saving logistics of goods, which is in contrast for example to rigid boxes and containers. Empty conveying pockets with a compressed receiving compartment can thus be stored or conveyed in a space-saving manner. The receiving compartments do not need to be expanded to the extent that they take up space until the transport or storage of the goods.

EP 2 418 160 B1 shows another loading station for transport pockets which are transported in a suspended conveying facility. The transport pockets comprise a frame bow which is suspended on a conveying element and on which two ends of a flexible material web are fastened and form a pouch. A pressure plate is arranged below the suspension hook of the pouch. A skid is arranged in the loading station, said skid on movement of transport pocket through the loading station pressing the pressure plate and thus also the transport pocket from an orientation transverse to the conveying direction into an orientation parallel to the conveying direction and holding it in this orientation over the course of the skid. The shape of the suspension hook is selected such that herein this is pressed upwards in the carrier hook of the conveying element away from a minimum of the potential energy. At the same time, the frame bow is also pressed outwards perpendicularly to the conveying direction and assumes a position in which the pouch is open to the top. In this position, the transport pocket can be filled from the side through the upper opening. After leaving the region of the skid, the suspension hook slides on the carrier hook back again to the minimum of potential energy and the pocket pivots back into an orientation transverse to the conveying direction.

The publication document CH 720 950 A1 describes a conveying pocket for a suspended conveying facility for the suspended conveying of a conveyed item along a conveying track, wherein the conveying pocket considered in the conveying direction comprises a front pocket wall and a rear pocket wall which trails the front pocket wall, said pocket walls being connected to one another by a pocket base, and the front and rear pocket wall together with the pocket base delimit a main receiving compartment which is open to the top through a pocket opening. The conveying pocket further comprises a holding device for the clamping receiving of an extensive conveyed item on the outer side of at least one of the pocket walls, in particular the rear wall.

The already mentioned publication document DE 10 2004 018569 B4 shows a further device for loading transport pockets in a suspended conveying facility. The transport pockets comprise a frame bow which is suspended on a conveying element transversely to the conveying direction and which defines an upper opening of the pocket. A flexible material web which is fastened to the frame bow at two ends forms a pouch for receiving individual item elements. Side walls only close a lower part of the sides of the pouch, so that lateral insert openings remain. On moving the transport pockets along the conveying path through the device, suitably designed slotted guides move the frame bow which is suspended in a perpendicular manner in the empty state of the transport pocket into a horizontal position in which the lateral insert openings are maximally opened. The articles can now be manually inserted into the pocket through the lateral openings. An automatic filling is not possible since the upper openings of the pockets are not accessible due to the runner rail of the conveying system.

WO 2018/142242 A1 shows a conveying unit for the suspended transport of transport elements in a conveying system, in particular in a rail-led conveying system or in a conveying chain system. The conveying system comprises a carrier hook which is attached to a conveying element, in particular to a runner vehicle or a conveying chain link, and further comprises a transport element and a suspension hook which is attached to the transport element, wherein the suspension hook is mounted in the carrier hook in a suspended manner. The carrier hook is designed in a manner such that the suspension hook can assume two stable positions in the carrier hook. The suspension hook in a first stable position is rotated by an angle with respect to the suspension hook in a second stable position. The conveying system is designed with active arrangements for the active rotation of the transport pocket.

Modern transport elements such as for example transport pockets in suspended conveying facilities can comprise several receiving spaces for conveyed items. The several receiving spaces can be designed differently, depending on which conveyed item is to be conveyed. Given the lateral filling of the transport pockets with conveyed items from above, there arises the problem that the transport pockets are to be brought to the loading position in the correct alignment, in order to be able to efficiently carry out the filling. The transport pockets should be led onto the loading position in a correctly aligned manner, even for a manual filling of the transport pockets, thus by hand.

Transport pockets can hence be equipped with several receiving compartments which can be located on different side walls of the transport pockets. For filling the individual receiving compartments with conveyed items, it is consequently necessary for the transport pocket to be brought into the correct alignment before reaching the loading position, so that the conveyed item can be inserted into the envisaged receiving compartment. If the transport pocket is conveyed to the loading position in an incorrect alignment, it is necessary to manually rotate the transport pocket into the correct position, and such delays the loading or can lead to errors on loading the transport pockets.

Often, different conveyed items cannot be conveyed in the same transport pockets since the volume or the weight or the nature of the conveyed items is significantly different. Thus transport pockets with fabric pouches, so-called “soft pouches” are only suitable for some of the conveyed items given the suspended conveying of conveyed items. Other solutions for conveying need to be provided for the remainder of the items.

Generally, there is the need for advancements in this field of technology.

### DESCRIPTION OF THE INVENTION

It is an object of the invention to provide a conveying unit for the suspended transport of transport elements in a conveying facility, in particular in a rail-led conveying facility or in a conveying chain facility, such being a simple and efficient solution for being able to convey different items by way of one conveying unit.

Another object of the invention is to provide a corresponding conveying facility with these conveying units.

These and other objects are achieved by a conveying unit according to the invention and a conveying system according to the invention, according to the independent claims. Further embodiments and further developments are specified in the dependent claims.

According to the invention, a conveying unit for the suspended transport of conveyed items in a conveying facility, in particular in a rail-led conveying facility or a conveying chain facility is provided.

The conveying unit comprises a conveying element, in particular a runner vehicle or a conveying chain link, with a first connection member such as a carrier hook, which is attached to the conveying element, and a transport element which is provided with a frame structure and is with a second connection member such as a suspension hook, which is attached or arranged on the frame structure. The first connection member such as suspension hook is mounted in a suspended manner on or in the second connection member such as a carrier hook of the conveying element.

The transport element comprises two transport pockets or consists of these, said transport pockets each comprising a leading and a trailing pocket wall in the conveying direction F. The leading and the trailing pocket wall of the two transport pockets are connected to one another via a pocket base section. The pocket walls of the two transport pockets consist of different materials, wherein the pocket wall material of the first transport pocket consists of a soft, supple material and the pocket wall material of the second transport pocket consists of a shape-stable, firm material.

The frame structure can form an open or closed frame.

The frame structure in particular forms a carrier frame for a transport pocket, in particular for the first transport pocket.

In a further development, the frame structure is formed from a wire material.

A wire is to be understood as a long, thin metal stand which is flexible enough to be able to be bent, but stable enough to be able to transmit forces. The wire can have a thickness of up to 10 mm, in particular of up to 6 mm.

The frame structure however can also consist of strands of plastic, in particular fibre-reinforced plastic.

In a further development, the two transport pockets are connected to one another via the frame structure.

The frame structure can be part of the first transport pocket.

The frame structure in particular comprises an upper transverse strut which forms an upper edge. The upper transverse strut in particular is arranged transversely to the conveying direction in the conveying position of the transport element.

The frame structure in particular comprises a lower transverse strut which forms a lower edge. The lower transverse strut in particular is arranged transversely to the conveying direction in the conveying position of the transport element.

The two transport pockets in particular are each connected to the upper transverse strut. The two transport pockets in particular are connected to one another via the upper transverse strut.

The second connection member such as suspension hook in particular is connected to the upper transverse strut of the frame structure or is arranged on this. The suspension hook can be a part, in particular an integral constituent of the upper transverse strut or be shaped from this.

In a further development, the pocket wall material of the first transport pocket consists of a sheet-like material.

In a further development, the pocket wall material of the first transport pocket consists of a fabric, a non-woven, felt, a foil material, a rubber or a silicone rubber.

According to a further development, the pocket wall material of the second transport pocket is flexurally rigid or stiff or rigid.

In a further development, the pocket wall material of the second transport pocket consists of a plastic material or a hollow chamber material or of a composite material or of a multi-layer material or of a metal.

In a further development, the first transport pocket is the leading transport pocket in the conveying direction and the second transport pocket the trailing transport pocket.

In an alternative further development, the first transport pocket in the conveying direction is the trailing transport pocket and the second transport pocket the leading transport pocket.

In a further development, the conveying unit comprises identification means, in particular on the runner vehicle. The identification means can be an RFID-tag, a QR-code or a barcode.

In a further development, the two transport pockets of each transport element comprise different identification means.

In a further embodiment, the two transport pockets of each transport element comprise different transport pocket types which in particular have different receiving volumes for conveyed items.

In a further embodiment, the conveying element has a vertical rotation axis, about which the conveying element or both transport pockets are commonly rotatable. The rotation axis in particular corresponds to a middle longitudinal axis of the transport element.

In a further embodiment, the two transport pockets considered in the conveying direction can be rotated to the right in order to load the second transport pocket or the two transport pockets considered in the conveying direction can be rotated to the left in order to load the first transport pocket.

In a preferred embodiment of the invention, the second transport pocket is pivotably fastened to the frame structure, in particular to the first transport pocket, along the conveying direction.

In a further preferred embodiment of the invention, the second transport pocket is fastened to the frame structure or to its upper transverse strut, in particular to the first transport pocket, by way of at least one fabric loop, in particular several fabric loops, which are fastened e.g. to the second transport pocket, e.g. sewn on.

In a further embodiment of the invention, the second transport pocket is provided with a pivotable frame which is pivoted open for filling the transport pocket.

In a preferred embodiment of the invention, the second transport pocket comprises two shape-stable plates which serve as a leading and trailing pocket wall which are pivotably connected to one another via a pivot connection or pivot hinge on the pocket base, or consists of these.

According to a further development, the second transport pocket can be folded open or collapsed, in the manner of a parallelogram. The pocket base is hereby in particular likewise designed as a shape-stable plate.

In a particularly preferred embodiment of the invention, the second transport pockets consist of two shape-stable plates which serve as a leading and trailing pocket wall, wherein the two plates in particular comprise a closure connection at an upper region. This closure connection can consist of a Velcro connection or a magnetic connection or of a clamping connection or of a hook connection.

The transport pocket in particular can be designed as a clamping pocket, concerning which the leading and trailing, shape-stable pocket walls are pivotably connected relative to one another via a pivot connection, such as pivot hinge or fabric strip. The pocket base here is formed by a pivot connection.

In a preferred embodiment of the invention, the runner vehicle and/or the transport pockets are provided with identification means, so that they can be unambiguously recognised by detection devices in the conveying facility.

In a further embodiment, a conveying facility for the suspended transport of conveyed items along conveying rails, in particular a rail-led conveying facility or conveying chain facility is provided, such comprising at least one conveying unit according to one of the aforementioned features.

Conveying units for the suspended transport of transport elements in a conveying system, in particular a rail-led conveying facility or a conveying chain facility can be provided with a carrier hook which is attached to a conveying element, in particular to a runner vehicle or a conveying chain link.

The conveying chain facility in particular is likewise guided by rail by way of the conveying chain with the conveying chain links being led along or in a rail, such as hollow rail.

In turn, the transport element can be provided with a second connection member such as a suspension hook, wherein the second connection member such as suspension hook is mounted in the first connection member such as a carrier hook, in a suspended manner.

In particular, a carrier hook is designed in a manner such that a suspension hook can assume at least three stable positions in the carrier hook. Hereby, the suspension hook in a first stable position is rotated about an angle with respect to the suspension hook in a second stable position, i.e. in relation to a second stable position of the suspension hook. Furthermore, the suspension hook in the first stable position is rotated with respect to the suspension hook in a third stable position, i.e. in relation to the third stable position of the suspension hook, about an angle which is different than that in the second stable position.

In the first stable position, the transport element is situated in particular in a conveying position. In the second stable position, the transport element in particular is situated in a loading or unloading position. In the third stable position, the transport element in particular is situated in a loading or unloading position.

“Stable position” in particular means that the suspension hook or the conveying element with the suspension hook remains in its position or rotation position on the carrier hook in an idle position. “Idle position” in particular means that the associated conveying unit is not situated in a conveying movement. This can be the case e.g. at a loading or unloading station.

The suspension hook remaining in the “stable position” can be effected without outside intervention. In particular, this is the case at the first stable position.

The suspension hook remaining in the “stable position” can also be effected by a stop element which from the outside acts upon the suspension hook or the transport element in the stable position. The stop element e.g. in a stop position in which the transport element or the suspension hook hits or abuts upon the stop element, prevents a pivoting of the transport element from the second or third stable position back into the first stable position.

The carrier hook can be an open or closed hook. A closed hook can be present e.g. as an eyelet which is to say an annular or loop-like body.

The suspension hook can be an open or closed hook. A closed hook can also be present e.g. as an eyelet which is to say an annular or loop-like body.

A further advantageous development of the conveying unit is effected by way of the suspension hook being able to be brought to and fro between the first stable position and the second stable position and the third stable position in a manner such that the suspension hook constantly lies on the carrier hook.

A further advantageous embodiment of the conveying unit is disclosed by the invention, wherein the carrier hook comprises or forms a first rest position or location, a second rest position or location and a third rest position or location, for the suspension hook.

The suspension hook in the first stable position lies on the first rest position or location, in the second stable position on the second rest position or location, and in the third stable position on the third rest position or location. A connection segment is arranged between the first rest position or location and the second rest position or location and the third rest position or location, on which connection segment the suspension hook can be brought to and fro between the first stable position, the second stable position and the third stable position in a sliding manner.

The connection segments are designed e.g. as arm sections.

A further advantageous development of the conveying unit is specified by the invention, wherein the carrier hook is designed in such a manner that in a certain first spatial orientation or arrangement of the first rest position or location of the carrier hook, the suspension hook on the first rest position or location can assume the first stable position in which the suspension hook is aligned in the first plane, and in a second spatial orientation or arrangement of the second rest position or location of the carrier hook which is different from the certain first spatial orientation arrangement, the suspension hook on the second rest position or location can assume the second stable position in which the suspension hook is aligned in a second plane, and in a third spatial orientation or arrangement of the third rest position or location of the carrier hook which is different to the certain second spatial orientation or arrangement, the suspension hook on the third rest position or location position can assume the third stable position in which the suspension hook is aligned in a third or the second plane.

In a certain first spatial orientation or arrangement of the first rest position or location of the carrier hook, the first position in particular corresponds to a minimum of the potential energy of the transport element which is mounted in a suspended manner.

The suspension hook in the first stable position in particular has a lower or the lowest potential energy compared to the second and third stable position.

Thus, the first rest position or location and herewith also the suspension hook in the first stable position in particular lies at a lower level along a horizontal conveying path considered in the direction of gravity in comparison to the second and third rest position or location which is to say or the second and third stable position.

By way of rotating the suspension hook about a certain rotation angle, e.g. by 90° (angle degrees) this can be brought to and fro between the first position and the second position or between the first position and the third position on the carrier hook.

The first, second and third rest locations on the carrier hook in particular have spatial orientations or arrangements which as mentioned are different to one another. According to a further development, the first rest position in a projection of the rest in a plane perpendicular to the conveying direction in particular is arranged between the second and third rest location. The first rest location in particular is arranged in a manner leading the second and third rest location in the conveying direction.

The conveying unit according to the invention then in a further development comprises a transport element with a suspension hook, wherein the suspension hook can be brought to and fro between the first stable position and the second stable position and the third stable position by way of rotating the transport element about a vertical of the conveying direction, e.g. about 90°.

The conveying unit according to the invention in a further development comprises a transport element, wherein the transport element comprises a first transport pocket which forms a carrier pouch as a receiving compartment for conveyed items. Such transport pockets in particular are also denoted as a soft pouch.

The conveying unit according to the invention in a further development comprises a transport element, wherein the transport element comprises a second transport pocket which forms a joint pocket as a receiving compartment for conveyed items.

A transport pocket, in particular the first transport pocket with a carrier pouch in particular is characterised in that the transport pocket comprises a frame structure, in particular the aforementioned frame structure, on which the ends of a web of sheet material such as a fabric web are fastened, said web forming a carrier loop. One end of the mentioned web of sheet material can be fastened to the lower transverse strut and the other end of the web can be fastened to the upper transverse strut of the frame structure.

The transport pocket can be provided with fabric-like side walls and thus form a transport pocket with a carrier pouch. The carrier loop in particular forms a leading and trailing which is to say front and rear pocket wall, as well as a pocket base section. The transport pocket can further be provided with flexible, such as net-like or fabric-like side walls.

A transport pocket, in particular the second transport pocket, with a joint pocket in particular is characterised in that the transport pocket comprises firm walls, such as a leading and trailing, which is to say front and rear pocket wall as well as a pocket base section which are connected to one another in the manner of a joint. The transport pocket can be provided with flexible, in particular net-like and fabric-like side walls and despite this form a shape-stable transport pocket.

A soft pouch, in particular its leading and trailing which is to say front and rear pocket walls as well as the pocket base section consists or consist of flexible supple material such as for example fabric material. It is for this reason that the aforementioned first transport pocket in particular is a soft pouch.

The first transport pocket, such as soft pouch can be designed in a manner such that it can be emptied to the bottom. For this, one can for example envisage the one end of the sheet-like material web being arranged in a manner releasable from the frame structure. For this, e.g. a carrier loop via which the sheet-like material web is fastened to the frame structure can be designed in a manner removable from the frame structure. Thus the carrier loop e.g. via Velcro or popper button connection can be reversibly opened and closed. Alternatively, the sheet-like material web e.g. via a carrier loop can be fastened to a carrier rod which can be removed from the frame structure. In this manner, the material web can pivot away amid the release of an opening. The carrier rod can be hung e.g. in the frame structure.

The conveying unit according to the invention comprises a transport element, wherein the transport element comprises at least two, in particular exactly two transport pockets. One of the transport pockets is provided with a shape-stable, firm pocket wall, in particular a shape-stable, firm, leading and trailing, which is to say front and rear pocket wall, as well as in particular also a shape-stable, firm pocket base section which in particular consists at least partly of a hollow chamber plate.

A “hard pouch” in particular its leading and trailing, which is to say front and rear pocket wall consists or consist in particular of shape-stable, firm material such as for example plastic, and the second transport pocket is therefore a hard pouch.

According to a further development of the second transport pocket, in particular the hard pouch, the pocket base section which in particular is connected to the front and rear pocket wall in an articulated manner also consists of a shape-stable, firm material. The pocket base section however can also consist of a flexible sheet material such as fabric, net or plastic.

According to a further development of the second transport pocket, in particular of the hard pouch, this can be emptied to the bottom. The second transport pocket in particular comprises a pocket base flap which can be opened and which forms the pocket base section.

The conveying unit according to the invention comprises a transport element, wherein the transport element comprises at least two, in particular exactly two transport pockets, wherein one transport pocket is provided with a flexible, supple pocket wall, in particular comprising the leading and trailing which is to say front and rear pocket wall as well as the pocket base section and at least partly consists of a web of sheet material, such as fabric web.

In particular therefore, the transport element can consist of a soft pouch and a hard pouch. This has the advantage that the most varied of conveyed items can be conveyed with the transport unit. Thus, the soft pouch can be applied for special conveyed items for the soft pouch and the hard pouch can be applied for special conveyed items for the hard pouch. Thus a greater number of conveyed items of different types can be conveyed with the same conveying units in the same suspended conveying facility. Herewith, the capacity of the suspended conveying facility can be significantly expanded.

The conveying unit according to the invention thus comprises a transport element, wherein the transport element comprises different types of transport pockets.

The conveying unit according to the invention or the associated transport element in particular comprises transport pockets such as a first and second transport pocket, wherein the transport pockets each comprise a rear pocket wall and a front pocket wall which are flexibly connected to one another via a pocket base section in a manner such that they can be brought between a first state in which they form a receiving compartment which is open to the top and can be filled from above, and a second state in which lying tightly and compactly next to one another they form a folded together transport pocket. These states in particular can be reached by way of moving to and fro which is to say by way of moving a frame of the transport pocket up and down, said frame forming a pocket opening.

The two transport pockets in particular face one another with their rear pocket walls. The two transport pockets in particular bear on one another via the rear pocket wall.

The conveying unit according to the invention with at least two, in particular exactly two transport pockets forms a receiving compartment for conveyed items for each transport pocket, wherein each receiving compartment of the at least two transport pockets can receive at least one conveyed item.

A rotation device of the conveying facility which is arranged e.g. on the conveying rail, for rotating the transport elements of conveying units, rotates the transport elements about their vertical rotation axis or about the middle longitudinal axis of the transport elements.

The rotation device is characterised in that activatable active elements can be brought into the path or the conveying corridor of the transport elements such that the transport elements in the conveying direction can rotate to the right or to the left about their vertical axis, before the transport pockets reach a loading position in a loading station of the conveying facility.

A loading device can be provided for loading the transport elements with conveyed items in the conveying facility, wherein the loading with conveyed items is effected transversely to the conveying direction of the conveying element, in particular from the side. By way of the rotation device, the transport elements are rotated about their vertical axis into the alignment which is envisaged for loading before the loading in the loading station.

A conveying facility according to the invention for the guided, suspended transport of conveying units is equipped with transport elements in the form of transport pockets which are led along a conveying rail, wherein the rail-led conveying facility is provided with at least one conveying unit with two different types of transport pockets.

The transport pocket for conveying units or the conveying unit can comprise a suspension hook in the upper part of the frame structure or of the carrier frame, said suspension hook in turn in particular being designed as an eyelet, wherein this eyelet of the suspension hook is rotated at right angles with respect to the carrier frame of the transport pocket.

The suspension hook can also be attached to the frame structure or to the carrier frame in a movable manner. In this case, the frame structure or carrier frame and the suspension hook are two separate parts which in particular can be rotated or pivoted with respect to one another.

The control device of the conveying facility controls the complete course of the devices. Thus a control centre can be additionally present, said control centre being designed to control the flow of goods within the conveying facility.

The control device in particular also controls a stop and release device of the conveying facility, in order on the one hand to be able to stop the conveying units, but on the other hand to also be able to release the conveying units for the conveying.

The invention is described for a conveying facility with an outer runner as a runner vehicle. Of course, the conveying facility according to the invention is also suitable for inner runners as runner vehicles of the conveying facility, wherewith this invention also encompasses an inner runner facility.

As mentioned, a conveying unit can comprise several transport pockets for conveyed items, in particular different transport pockets for different types of conveyed items. A transport element of a conveying unit can comprise two different transport pockets which can each receive different item types, or consist of these pockets. A conveying unit can comprise precisely one transport element.

The receiving spaces or receiving compartments of the transport pockets can be closable. In particular, the conveyed item is held and conveyed in a carrying manner.

The conveyed item however can also be held in a clamping manner during the conveying. The conveyed item can be conveyed held in a clamping manner between the front wall and the rear wall during the conveying. In particular, this relates to a clamping pocket.

Considered in the conveying direction, transport pockets can be either rotated to the left or to the right with the help of a rotation device. Herewith, different transport pockets can be filled with conveyed items by way of a loading device. In particular, different receiving compartments can also be loaded with conveyed items.

As mentioned, the frame structure can be designed as a carrier frame, in particular of the transport pocket. The frame structure in particular can be designed as a carrier frame of the first transport pocket which is e.g. a soft pouch.

The frame structure or the carrier frame can be of one part or however constructed in a multi-part manner. The carrier frame in particular is a synonym for the frame structure which comprises a frame-like structure. On the one hand the frame structure or the carrier frame in particular can be hung onto the carrier hook via the suspension hook. On the other hand, the frame structure or the carrier frame forms a frame on which the carrier loop of the pocket pouch e.g. of the first transport pocket is fastened.

The frame structure or the carrier frame can moreover form a, e.g. rectangular loading opening of the respective transport pocket.

Transport elements according to the invention however can also be or encompass transport baskets which transport the conveyed items. Thus, transport baskets as a rule comprise deposition locations at which the conveyed items can be deposited. These transport baskets can also be rotated and aligned for the loading or the unloading. The transport baskets are e.g. second transport pockets.

Suspended conveying facilities can be part-facilities of conveying facilities. Hence conveying facilities are superordinate facilities which can also encompass lying conveyors, warehouses, pallet warehouses, high bay warehouses and also warehouse management computers.

A conveying unit in particular consists of a conveying element in the form of a roller vehicle or runner vehicle and a transport element with at least two transport pockets which can receive individual items for the transport.

The individual items can be goods, articles, consumer good, individual parts but also smaller containers. Individual items significantly differ from one another in their size, their inner nature and their weight and their sensitivity to pressure and effort in handling.

The transport pockets can receive individual items at loading stations in an automated manner and deliver them at unloading stations in an automated manner.

A significant aspect of the invention also relates to a conveying facility which comprises at least one suspended conveying facility which applies at least one conveying unit for conveying conveyed items, as is described above. The conveying facility can furthermore comprise for example a conveying section, buffers for empty conveying units, drive units for the conveying units, a stop device for conveying units, sorting systems such as for example a matrix sorter, switchable points, buffer stores, loading stations, unloading stations, measuring stations for conveying units or conveying pockets, revolving conveyors, palletising devices, forwarders, dispatch locations, identification devices and control devices.

The subject-matter of the invention is hereinafter explained in more detail by way of embodiment examples which are represented in the accompanying figures.

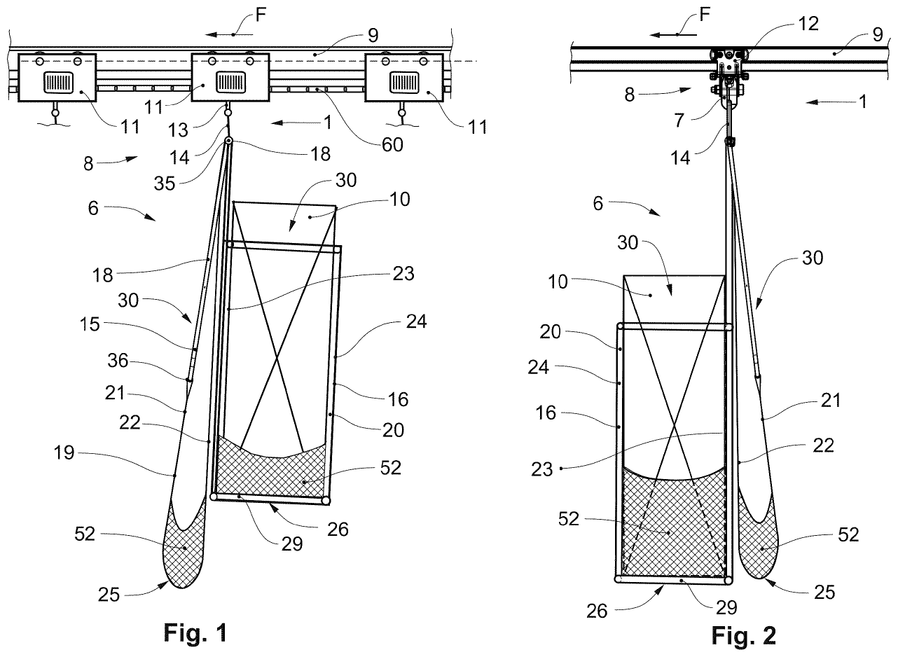

FIG. 1 in a lateral view shows a conveying unit, consisting of a conveying chain link and a transport element which consists of two transport pockets.

FIG. 2 in a lateral view shows a conveying unit which is applied in a suspended conveying facility, consisting of a runner vehicle and a transport element which consists of two transport pockets.

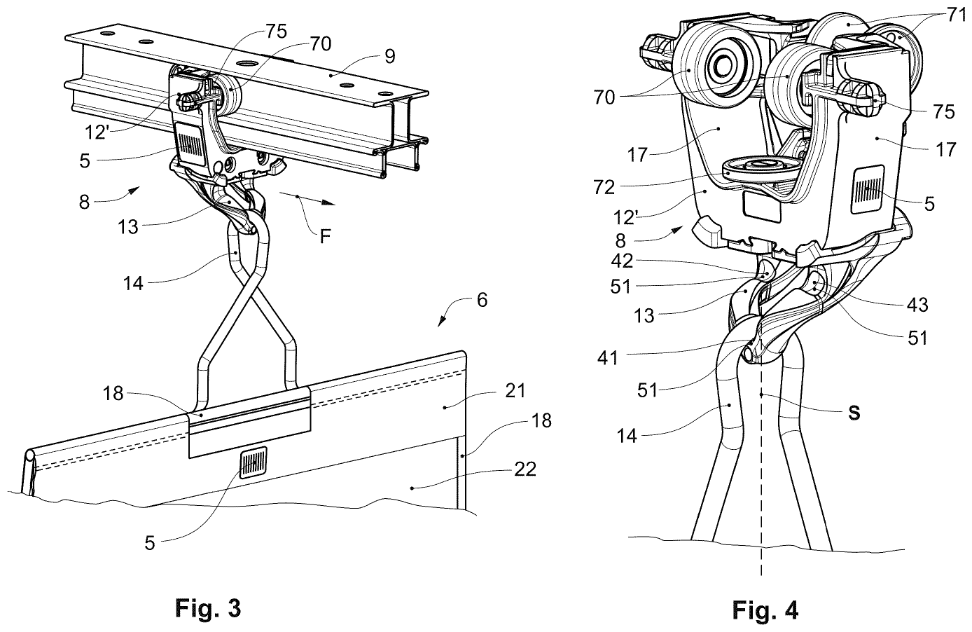

FIG. 3 in a perspective view shows a runner vehicle arranged in a conveying rail with a transport element on the carrier hook of the runner vehicle.

FIG. 4 in a perspective view shows a runner vehicle according to FIG. 3 in an enlarged representation.

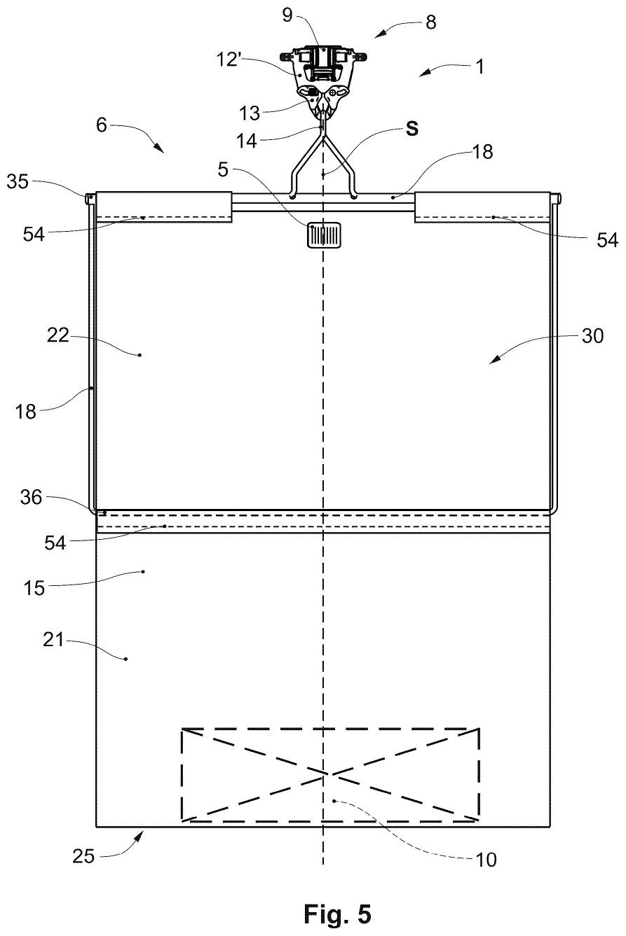

FIG. 5 in a plan view shows a conveying unit which is applied in a suspended conveying facility.

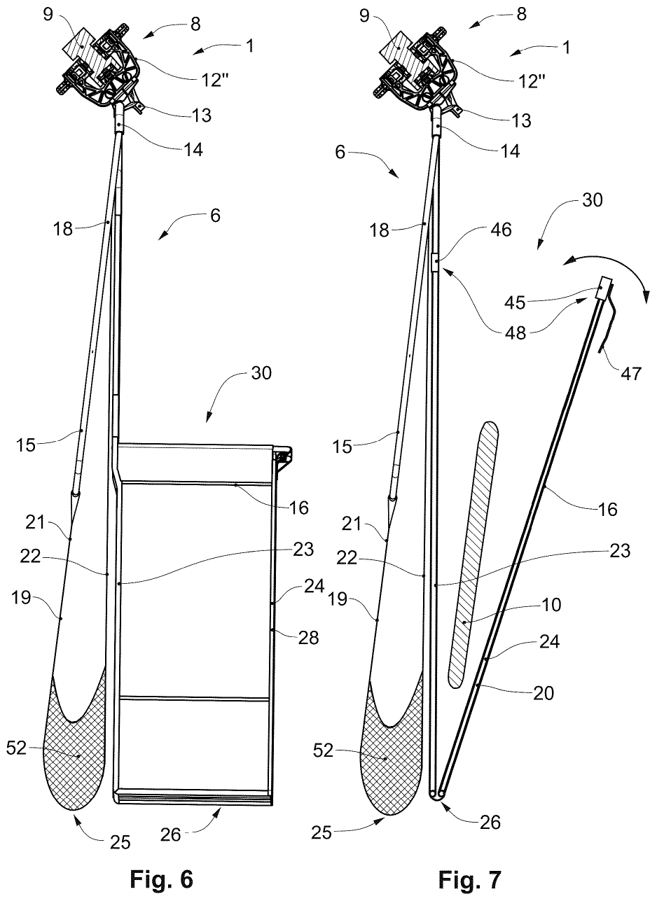

FIG. 6 in a lateral view shows a further conveying unit, wherein the second transport pocket is designed as a transport basket.

FIG. 7 in a lateral view shows a further conveying unit, wherein the second transport pocket is designed as a clamping pocket.

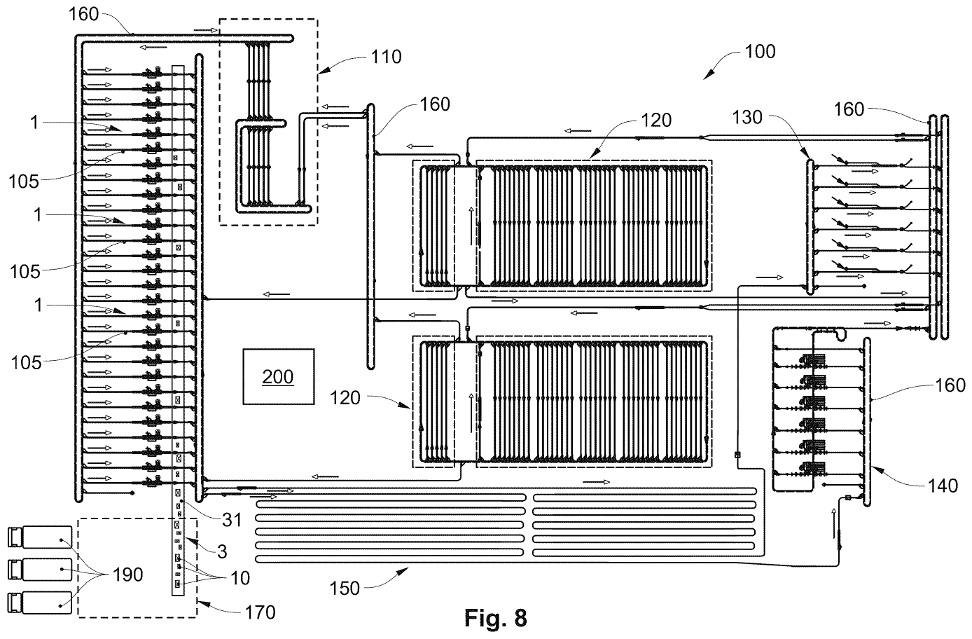

FIG. 8 schematically shows a conveying facility in which the conveying units are applied for the conveying of conveyed items.

The embodiment examples which are described hereinafter are merely to be understood as exemplary of the subject-matter of the invention and have no limiting effect. Basically, in the figures the same parts are provided with the same reference numerals.

FIG. 1 shows a conveying unit 1 with a conveyed item 10 in the lateral view. The conveying unit 1 consists of a conveying element 8 in the form of a conveying chain link 11 and a transport element 6. The individual conveying chain links 11 are connected to one another by way of a chain 60, wherein the chain 60 with the conveying chain links 11 forms a continuous revolving apparatus. The conveying chain links 11 are provided with identification tags 5 in order to permit an unambiguous assignment of the transport pockets 15, 16 over the conveying chain links 11.

The transport element 6 consist of two transport pockets 15, 16, wherein the first transport pocket 15 consists of a flexible, supple material and the second transport pocket 16 of a shape-stable, firm material. The first transport pocket 15 comprises a frame structure 18 on which a fabric loop which is designed as a carrier loop 19 is fastened. The upper end of this fabric loop is fastened to an upper transverse rod of the carrier frame or the frame structure 18. The other end of the fabric loop is fastened to a lower transverse rod of the frame structure 18 of the transport pocket 15.

The conveying element 8 consists of a conveying chain link 11 with a carrier hook 13 on which the two conveying pockets 15, 16 or transport pockets are suspended.

The conveying chain link 11 runs in the conveying direction F in a conveying rail 9 in a guided manner. The carrier frame 18 of the first transport pocket 15 forms a loop-like eyelet at the upper end, said eyelet being used as a suspension hook 14 of the first transport pocket 15 or of the transport element 6. The suspension hook 14 of the carrier frame 18 of the first transport pocket 15 is hung in the carrier hook 13 of the conveying chain link 11. The second transport pocket 16 is fastened to the carrier frame 18 of the first transport pocket 15 in a manner such their two pocket rear walls bear on one another.

The two pocket rear walls are characterised in that they have no loading openings. The connection of the two transport pockets can also be effected via fabric tabs on the carrier frame 18. The pocket wall 23 can advantageously be fastened onto fabric tabs by way of seams 54.

The frame structure or the carrier frame 18 of the first transport pocket 15 consists of a shaped wire which forms a closed frame which corresponds to the shape of a wire frame. The upper end of the suspension hook 14, thus the eyelet is advantageously rotated by 90° to the frame structure 18 or to the carrier frame 18. The wire frame forms the pocket opening 30, through which the first transport pocket 15 can be filled with conveyed items 10 such as for example articles. The rear pocket wall 22 which forms the rear wall of the first transport pocket 15 is situated behind the pocket opening 30. The front pocket wall 21 is fastened to a lower edge 36 of the carrier frame 18 and forms the front pocket wall 21 of the transport pocket 15. The front pocket wall 21 here is the pocket wall which leads in the conveying direction F. The rear pocket wall 22 here is the pocket wall which trails in the conveying direction F. The two pocket walls 21, 22 are connected to one another at the bottom by way of the pocket base section 25. The space which is delimited between the front pocket wall 21, the rear pocket wall 22 and the pocket base section 25 is a receiving compartment and is used for receiving conveyed items 10.

The second transport pocket 16 is arranged on the first transport pocket 15 in a manner such that the pocket rear walls bear on one another. The second transport pocket 16 has a receiving compartment for the conveyed items 10. The transport element 6 has vertical rotation axis S (see FIG. 5) in its middle, said rotation axis in particular lying in the middle longitudinal axis of the transport pocket and about which the two transport pockets 15, 16 can be rotated, which is to say can be pivoted. The transport pockets 15, 16 can be driven via the conveying chain link 11 by way of the chain 60 and a drive device, wherein the drive device is not shown here.

The second transport pocket 16 consist of shape-stable, firm pocket walls 23, 24 which are connected to one another by the pocket base section 26 via articulated connections and form a joint pocket 20. Articulated struts are arranged between the pivotable pocket walls 23, 24 so that the pocket walls can be displaced to one another. Hereby, the pocket walls 23, 24 remain approximately parallel. In the upper region, a loading opening 30 arises between the two pocket walls 23, 24 on opening the second transport pocket 16 when the two pocket walls 23, 24 are moved apart.

Both transport pockets 15, 16 comprise side walls 52 of a net-like material. This net-like material can be stretched and adapts to the movements as well the different loading states of the transport pockets.

FIG. 2 shows a conveying unit 1 with a conveyed item 10 in the lateral view. The conveying unit 1 consists of a conveying element 8 in the form of a runner vehicle 2 and a transport element 6, as is also shown in FIG. 1. The runner vehicle 12 runs in the conveying direction F in a conveying rail 9 in a guided manner. The frame structure 18 of the first transport pocket 15 at the upper end forms a loop-like eyelet which is used as a suspension hook 14 of the first transport pocket 15 or of the transport element 6. The suspension hook 14 of the frame structure 18 of the first transport pocket 15 is inserted or hung into a holder 7 of the runner vehicle 12. The two transport pockets 15 and 16 at their rear walls lie with one another or bear on one another. The connection is effected via the carrier frame 18 by way of the rear walls are fastened to the carrier frame 18 via fabric tabs. The transport pocket wall 23 can advantageously be fastened to the fabric tabs by way of seams 54. The holder 7 is fastened to the runner vehicle 12. The frame structure 18 is pivotably mounted in the holder 7 so that the transport element 6 can swing to and fro in the holder 7. The holder 7 further comprises an internal rotary joint, so that the transport element 6 can also rotate about its vertical rotation axis S.

In FIG. 2, the second transport pocket 16 is the leading transport pocket and the first transport pocket 15 is the trailing transport pocket, which is in contrast to FIG. 1. The leading second transport pocket 16 consists of a shape-stable, firm material. Advantageously, it consists of a metal frame with a hollow chamber plate as a filling material. The individual transport pocket parts such as pocket front wall 24, pocket rear wall 23 and the pocket base segment 26 or section are here connected to one another via joint connections 20. A pocket opening 30 is formed at the upper end of the pocket wall 4, into which opening a transport item 10 is filled.

Both transport pockets 15, 16 are also provided with side walls 52 of a net-like material in FIG. 2. This net-like material can be stretched and adapts to the movements as well as to the different loading states of the transport pockets 15, 16.

FIG. 3 and FIG. 4 show the runner vehicle 12′ which is provided with a carrier hook 13, each in a perspective view. This runner vehicle 12′ consists of a U-shaped main body which forms two runner vehicle limbs 17. A carrier roller 12 is arranged at the inner side on both runner vehicle limbs 17. The carrier rollers 13 assume the carrying load of the conveyed item 10. Two support rollers 71 which are orientated flush with the carrier rollers 70 are arranged behind the two carrier rollers 70. The carrier rollers 70 and support rollers 71 run in the conveying rail 9, wherein the runner vehicle 12′ is designed as an outer runner. Two guide rollers 72 are arranged one after the other below the carrier rollers 70 and the support rollers 71 in a manner such that their rotation axes are orientated orthogonally to the rotation axes of the carrier rollers 70 and support rollers 71. The guide rollers 72 serve for the lateral guidance of the runner vehicle 12′. The runner vehicle 12′ laterally on the runner vehicle limbs 17 each comprises a driver bolt 75 which projects outwards on the runner vehicle limb 17. The runner vehicle 12′ can be driven at the driver bolts 75 with the help of driver elements which are not shown here.

In FIGS. 3 and 4, a carrier hook 13 is fastened to the runner vehicle 12′ below the runner vehicle 12′. The fastening here is realised via a swallowtail guide which is secured via a snap connection 24. The connection between the runner vehicle 12′ and the carrier hook 13 can be released again. A suspension hook 14 is inserted or hung into the carrier hook 13 in FIGS. 3 and 4. The loop-like eyelet of the suspension hook 14 lies in the first stable position 4 of the carrier hook. A first stable position 41 or rest position of the carrier hook 13 is characterised in that the transport pocket 30 below the suspension hook 14 is aligned at right angles to the conveying direction F of the runner vehicle 12′. A rotating or pivoting of the transport element 6 about the vertical rotation axis S leads to a winding of the suspension hook 14 of the transport pocket 15 out of the first stable position 21 or rest location 41 of the carrier hook 13.

A rotating of the carrier frame 18 of the transport element 6 in the anti-clockwise direction leads to the eyelet of the suspension hook 14 winding itself out of the first stable position or rest location 41 and pushing upwards to the left along a connection segment until the eyelet of the suspension hook 14 reaches a second stable position 43 or rest location where the eyelet is held at least temporarily in a recess 51 at the second stable rest position 43. On account of the rotation of the carrier frame 18 of the transport pocket 15 or of the carrier element 6, the alignment of the transport pocket 15 or of the transport element 6 is now parallel to the conveying direction F of the runner vehicle 12′. The pocket opening 30 is aligned to the left considered in the conveying direction F of the runner vehicle 12′. The transport pocket 15 or the transport element 6 can now be filled for example from the left.

A rotating of the carrier frame 18 of the transport element 6 in the clockwise direction leads to the eyelet of the suspension hook 14 winding itself out of the first stable position 41 or rest location and pushing upwards to the right along a connection segment until the eyelet of the suspension hook 14 reaches a third stable position 42 or rest location where the eyelet is held at least temporarily in a recess 51 at the third stable rest position 43. On account of the rotation of the carrier frame 18 of the transport pocket 15 or of the transport element 6, the alignment of the transport pocket 15 or of the transport element 6 is now also parallel to the conveying direction F of the runner vehicle 12′. The pocket opening 15 is aligned to the right in the conveying direction F of the runner vehicle 12′. The transport pocket 15 or the transport element 6 can now be filled for example from the right.

The carrier hook 18 has three recesses 51 which form the mentioned stable positions or rest locations for the suspension hook 14, in which recesses the suspension hook 14 can assume a stable position. In each of the three stable positions 41, 42, 43, the transport pocket 15 has a different alignment to the conveying direction F of the runner vehicle 12′. On account of the different alignments of the transport pocket 30, different operations can be carried out with the transport pocket 15.

The second transport pocket 16 is fastened to the rear side of the first transport pocket 15, so that the pocket rear sides of both transport pockets 15, 16 bear on one another. The second transport pocket 16 is fastened to the first transport pocket 15 at an upper edge 35 of the carrier frame 18. If the first transport pocket 15 rotates to the left considered in the conveying direction F, then the second transport pocket 16 rotates to the right considered in the conveying direction F. The runner vehicle 12′ in the FIGS. 3 and 4 are provided with identification tags 5.

FIG. 5 shows the conveying unit 1 of FIG. 3 and FIG. 4 in a plan view or front view. The conveying unit 1 is inserted with its runner vehicle 12′ in the runner rail 9 and moves along this runner rail 9. The runner vehicle 12′ is provided with a carrier hook 13 in which the suspension hook 14 of the transport element 6 is inserted or hung. The suspension hook 14 is part of the carrier frame 18 which consists of a wire material. The carrier frame 18 comprises an upper edge 35 in the form of an upper transverse strut and a lower edge 36 in the form of a lower transverse strut. The pocket rear wall 22 of the first transport pocket 15 is sewn onto the upper edge 35 by way of seams 54 and the pocket front wall 21 of the first transport pocket 15 is also sewn onto the lower edge 36 by way of seams 54. The pocket front wall 21 is the leading pocket wall 21. The two pocket walls 21, 22 form a carrier loop of the first transport pocket 15 and are connected at the base by way of a pocket base section 25.

An identification tag 5 is attached to the trailing pocket wall 22 of the first transport pocket 15. The transport element 6 consists of two transport pockets 15 and 16. The second transport pocket 16 however is covered by the first transport pocket 15 in FIG. 5.

The carrier frame 18 can be rotated with its suspension hook 14 in the carrier hook 13. If the carrier frame 18 is pivoted or rotated in the direction of the leading pocket wall 21, the pocket opening 30 is opened, so that a conveyed item 10 can be brought into the pocket opening 30 into the first transport pocket 15. In FIG. 5, a conveyed item 10 is brought into the receiving space of the transport pocket 15 and is covered by the pocket front wall 21 and for this reason the conveyed item 10 is represented in a dashed manner.

FIG. 6 shows a conveying unit 1 which consists of a runner vehicle 12″ and a transport element 6. The runner vehicle 12″ runs along a conveying rail 9 in the conveying direction. The runner vehicle 12″ is designed as an injection moulded part and comprises a carrier hook 13 which has two stable positions for the suspension hook 14. The transport element 6 consists of the first transport pocket 15 with soft, supple pocket walls 21, 22 and the second transport pocket 16 of shape-stable, firm material and in FIG. 6 is designed as a transport basket 28. The first transport pocket 15 is the transport pocket which leads in the conveying direction F and the second transport pocket 16 is the transport pocket which trails in the conveying direction F.

The first transport pocket 15 consists of a carrier frame 18 which at its upper end forms a suspension hook 14 which is mounted in the carrier hook 13 of the runner vehicle 12″. The receiving space of the first transport pocket 15 is formed by a fabric web which is fastened to the carrier frame 18 such that a carrier loop 19 is formed. The second transport pocket 16 is attached to the upper edge 35 of the carrier frame 18. The second transport pocket 16 consists of shape-stable, firm materials.

In FIG. 6 the pocket walls are constructed of metal strips, metal wires or metal tapes. The second transport pocket 16 is designed as a transport basket 28 or as a transport mount. The second transport pocket 16 comprises a pocket opening 30 which is always or permanently open, for loading the transport basket 28.

FIG. 7 shows a conveying unit 1 which consists of a runner vehicle 12″ and a transport element 6. The runner vehicle 12″ runs along a conveying rail 9 in the conveying direction. The runner vehicle 12″ is designed as an injection moulded part and comprises a carrier hook 13 which has two stable positions for the suspension hook 14. The transport element 6 consists of the first transport pocket 15 with soft, supple pocket walls 21, 22 and of the second transport pocket 16 which is with shape-stable, firm pocket walls 23, 24 and is designed as a clamping pocket 20. The first transport pocket 15 is the pocket which leads in the conveying direction F and the second transport pocket 16 is the transport pocket which trails in the conveying direction F.

The first transport pocket 15 consists of a carrier frame 18 which at its upper end forms a suspension hook 14 which is mounted in the carrier hook 13 of the runner vehicle 12″. The receiving space of the first transport pocket 15 is formed by a fabric web which is fastened to the carrier frame 18 such that a carrier loop 19 is formed. The second transport pocket 16 is attached to the upper edge 35 of the carrier frame 18 of the first transport pocket 15.

The second transport pocket 16 consists of two pocket walls 23, 24 of shape-stable, firm materials. The rear wall 23 is somewhat longer than the front wall 24 and both pocket walls are hollow chamber plates and consist of plastic. Both pocket walls 23, 24 are pivotably connected in the lower end by way of a fabric strip, wherein the fabric strip forms a pocket base section 26. This transport pocket 16 is designed as a joint pocket 20 and in particular is particularly suited for conveying flat objects in a clamped manner.

A closure device 48 which is designed as a magnetic closure element 45 is located on the upper edge of the shorter, trailing pocket wall 24. A magnetic counter-closure element 46 is arranged on the other pocket wall 23, the leading transport pocket wall 23, at a corresponding height to the closure element 48 on the trailing transport pocket wall 24. The closure element 45 and the counter-closure element 46 form the closure device 48. The closure connection or closure device 48 can be opened by way of pulling on pull means 47 in the form of a tape. On opening the closure connection 48, the pocket wall 24 pivots open so that the receiving space for the conveyed item 10 is opened. The receiving opening 30 forms between the closure element 45 and the counter-closure element 46, so that the receiving space can be filled. As a rule the conveyed item 10 is conveyed in a clamping manner. However, it is also possible for the transport pocket 16 to comprise net-like side walls which secure the conveyed item from falling out.

FIG. 8 shows a conveying facility 100 which serves for processing conveyed items 10, such as for example at order picking centres. The conveying facility 100 encompasses loading stations 130 in which the transport pockets 15, 16 of the conveying units 1 are loaded with conveyed items 10. A matrix sorter 110 is likewise part of the conveying facility 100 and serves for sorting conveyed items 10 into defined sequences. A buffer 120 is provided as an intermediate store for the conveyed items 10 in order to optimise the throughput of the conveying facility 100 which is to say to increase the availability of individual conveyed items 10. Unloading stations 105 are present, at which conveyed items 10 in storage containers or transport containers in the form of crates or boxes can be loaded. The conveying facility 100 is controlled by way of the control device 200 which examines, controls and processes all conveying procedures. Several revolving conveyors 160 are applied in the conveying facility and these convey the conveyed items 10 in the conveying elements 8 towards the individual facility components 110, 120, 130, 140, 170.

Conveying containers for example can be suspended conveying pockets 15, 16 of a suspended conveying facility. A return station 140 is likewise part of the conveying facility 100, at which station conveyed items 10 which are returned by the customer can be examined and fed into the conveying facility.

An empty pocket store 150 is likewise part of the conveying facility 100 and empty transport units 1 are kept ready in this empty pocket store for the transport of conveyed items 10 and when required are transported out of the empty pocket store 150. The conveyed items 10 themselves are filled into conveying containers in the form of suspended conveying pockets 15, 16 and are transported along conveying rails 9 in order to transport the conveyed items 10 to different processing devices 110, 120, 130, 140, 170.

Transport containers such as for example boxes or also individual conveyed items 10 are conveyed from the delivery stations 105 to the dispatch 170 by way of a lying item conveyor 3 in the form of a conveyor belt 31. The loading of the conveyed items 10 into lorries 190 for external transport is effected in the dispatch 170.

The present invention is not limited in its scope to the specific embodiments which are described here. In contrast, different further modifications of the present invention result for the man skilled in the art from the description and the associated figures, additionally to the examples which are disclosed here, such further modifications likewise falling within the protective scope of the claims. Additionally, different references are cited in the description, the contents of whose disclosure is herewith incorporated in its entirely into the description by reference.

1. A conveying unit for the suspended transport of conveyed items in a conveying facility, in particular in a rail-led conveying facility or a conveying chain facility, with:
a conveying element, in particular a runner vehicle or a conveying chain link, with a first connection member such as a carrier hook which is attached to the conveying element, and with
a transport element which is provided with a frame structure, with a second connection member such as suspension hook which is attached to the frame structure,
wherein the first connection member such as suspension hook is mounted in a suspended manner in the second connection member such as carrier hook, of the conveying element, and the transport element consists of at least two transport pockets, wherein the transport pockets in the conveying direction each comprise a leading and a trailing pocket wall which are connected to one another via a pocket base section,
wherein the pocket walls of the two transport pockets consist of different materials, wherein the pocket wall material of the first transport pocket consists of a soft, supple material and the pocket wall material of the second transport pocket consists of a shape-stable, firm material.

2. The conveying unit according to claim 1, wherein the frame structure is formed from a wire material.

3. The conveying unit according to claim 1, wherein the two transport pockets are connected to one another via the frame structure.

4. The conveying unit according to claim 1, wherein the pocket wall material of the first transport pocket consists of a fabric, a non-woven, felt, a foil material, a rubber or a silicone rubber.

5. The conveying unit according to claim 1, wherein the pocket wall material of the second transport pocket consists of plastic material or a hollow chamber material or a composite material or a multi-layer material or of a metal.

6. The conveying unit according to claim 1, wherein the conveying element comprises or contains at least one, in particular two identification means, in particular on the runner vehicle.

7. The conveying unit according to claim 1, wherein the conveying unit comprises or contains different identification means for the two transport pockets of the transport element.

8. The conveying unit according to claim 1, wherein the two transport pockets of the transport element have a different receiving volume for conveyed items.

9. The conveying unit according to claim 1, wherein the transport element comprises a vertical rotation axis, about which both transport pockets are commonly rotatable.

10. The conveying unit according to claim 1, wherein the two transport pockets considered in the conveying direction can be rotated to the right in order to load the second transport pocket or the two transport pockets considered in the conveying direction can be rotated to the left in order to load the first transport pocket.

11. The conveying unit according to claim 1, wherein the first transport pocket in the conveying direction is the leading transport pocket and the second transport pocket the trailing transport pocket.

12. The conveying unit according to claim 1, wherein the frame structure is part of the first transport pocket, and the first transport pocket comprises a web of a sheet material such as fabric web, which with its ends is fastened to the frame structure and forms a carrier loop.

13. The conveying unit according to claim 1, wherein the frame structure comprises an upper transverse strut, and the first and second transport pocket are fastened to the upper transverse strut and in particular are connected to one another via the upper transverse strut.

14. The conveying unit according to claim 1, wherein the first and the second transport pocket each form a front and rear pocket wall and the two transport pockets with their rear pocket walls face one another and in particular bear on one another.

15. The conveying unit according to claim 1, wherein at least one, in particular both of the following subject-matter is the case:
the first transport pocket such as soft pouch is designed such that it can be emptied to the bottom;
the second transport pocket such as hard pouch is designed such that it can be emptied to the bottom.

16. A conveying facility for the suspended transport of conveyed items along conveying rails, in particular a rail-led conveying facility or a conveying chain facility, with at least one conveying unit according to claim 1.
